(19) United States
(12) Patent Application Publication
(10) Pub. No.: US 2015/0365206 A1
(43) Pub. Date: Dec. 17, 2015

(54) SYSTEM AND METHODS FOR INTERFERENCE MITIGATION IN FEMTOCELL NETWORK

(71) Applicant: QATAR UNIVERSITY QSTP-B, Doha (QA)

(72) Inventors: Elias YAACOUB, Doha (QA); Adnan ABU-DAYYA, Doha (QA)

(21) Appl. No.: 14/302,438

(22) Filed: Jun. 12, 2014

(51) Int. Cl. H04L 5/00; H04W 72/08; H04W 84/10

(52) U.S. Cl. CPC H04L 5/0035; H04W 84/10; H04W 72/085

(57) ABSTRACT

Disclosed are system and methods for interference mitigation in femtocell network by dynamically allocating the resource block (RB) to femto user equipment (FUE). The system comprises of at least a sensing module, at least a femto base station (FBS) module and at least a coordination module. The present invention involves a joint channel sensing and radio resource management (RRM) using the sensing module and the femto base station (FBS) module for dynamically allocating resource block (RB) to femto user equipment (FUE). The resource blocks (RBs) are allocated dynamically to femto user equipments (FUEs) by the femto base station (FBS) module based on the instructions of the coordination module.

### FIELD OF THE INVENTION

The present invention relates to wireless communication network, and more particularly to system and methods for interference mitigation in femtocell network.

### BACKGROUND OF THE INVENTION

Generally, the cellular networks are formed by a plurality of base stations (BSs) and user equipments (UEs). The base stations (BSs) may be a macrocell base station (MBS), a small cell base station (SCBS), a femto cell base station (FBS) and other base stations in terms of capacity and coverage. The capacity of a base station (BS) may be defined by the ability to connect with maximum number of user equipments (UEs) with maximum data rate and coverage is the maximum area up to which a base station (BS) may communicate with a user equipment (UE). The data rate of a base station (BS) is the speed with which it may communicate with the user equipments (UEs). User equipments (UEs) may be a macrocell user equipment (MUE), a small cell user equipment (SCUE), a femto cell user equipment (FUE) and other user equipments. The base station (BS) communicates with the user equipment (UE) over a channel, referred to as radio resources (RRs) through which data is sent and received. The radio resources may be further divided in to plurality of resource blocks (RBs). In a scenario, where numbers of base stations (BSs) are communicating with number of user equipments (UEs), then such communication results in a data traffic in the corresponding cellular network. The data traffic in a cellular network also increases the probability of interference where at least a base station (BS) or at least user equipment (UE) interferes in communication with other base station (BS) and other user equipment (UE).

With the increase in data traffic due to densification of user equipments (UEs) for a corresponding base station (BS), the need of deployment of additional base stations (BSs) in cellular networks has greatly increased. The increased number of base stations (BSs) and user equipments (UEs) results in a heterogeneous network (HetNet), where macrocell base stations (MBSs) cover areas that are relatively large, and coexists with small cell base stations (SCBSs) covering smaller areas and thus providing network access points (APs) at closer proximity to the user equipments (UEs) in order to enhance the capacity and data rates.

In the area with a large number of user equipments (UEs) where more number of large sized base stations (BSs) cannot be deployed to enhance the capacity and data rates while avoiding data traffic, there is a need for deployment of small sized indoor base stations, referred to as femto base station (FBS).

Majority of base stations (BSs) in heterogeneous networks (HetNets) generally communicate over a backbone network under the control of the mobile network operator (MNO). In the long term evolution (LTE) system and LTE-Advanced (LTE-A) system, the base stations (BSs) communicate over the X2 interface. However, femto base stations (FBSs) are mostly plug and play devices deployed by subscribers indoors. The indoors are primarily smaller premises. The femto base stations (FBSs) are connected to the network through, for example, digital subscriber lines (DSL). Hence, they do not have a backbone network and thus cannot perform fast coordination with other base stations (BSs) for interference mitigation and radio resource management (RRM). Since femto base stations (FBSs) are mostly user deployed and beyond the control of mobile network operator (MNO), they pose a challenge for radio resource management (RRM), interference mitigation from femto base stations (FBSs), and user equipments (UEs) in femtocell networks.

In terms of the solutions available for mitigating the above challenges, the femto base stations (FBSs) sense the channel before deciding which radio resources (RBs) to allocate to the Femto user equipment (FUE). Also, the solutions available for mitigating the above challenges consider a significant exchange of information between the macrocell base station (MBS) and femtocell base station (FBS), for example, by knowing all the allocation decisions of the macrocell base station (MBS) by the femto base station (FBS), knowing the positions of macro user equipments (MUEs), or an accurate estimate of the channel gain (CG) on the link between femto user equipment (FUE) and macrocell base station (MBS), and the links between femto base station (FBS) and all neighboring macro user equipments (MUEs).

Most of the solutions available for mitigating the above challenges involves a cognitive radio (CR) approach and use the vacant channels for femto base station (FBS) transmission. In the cognitive radio (CR) approach, sensing time and transmission time are separate. Such solutions may not be considered as the most efficient solutions for mitigating interference in femtocell network.

In view of the drawbacks inherent in the prior art, it is clear that there exist need to overcome the problems associated with the prior arts that have a limitation of sequential sensing and transmission and consider the aggregate interference only from all surrounding macrocell base stations (MBSs) and not from other femto base stations (FBSs).

Accordingly, what is required is a low complexity, distributive approach for interference mitigation by dynamically allocating resource block (RB) to the femto user equipment (FUE) while simultaneously sensing and transmission of resource blocks (RBs). Further, said required approach is also capable of considering the aggregate interference from all surrounding macrocell base stations (MBSs) as well as femto base stations (FBSs) without excessive information exchange between femto base stations (FBSs), and between femto base stations (FBSs) and macrocell base stations (MBSs).

### SUMMARY OF THE INVENTION

In view of the foregoing disadvantages inherent in the prior-art, the general purpose of the present invention is to provide methods and system for interference mitigation in femtocell network that is configured to include advantages of the prior art and to overcome the drawbacks inherent in the prior art offering some added advantages.

In one aspect, the present invention provides a low complexity, distributive approach for interference mitigation by dynamically allocating resource block (RB) to the femto user equipment (FUE) while simultaneously sensing and transmission of resource blocks (RBs). The distributive approach also considers the aggregate interference from all surrounding macrocell base stations (MBSs) as well as femto base stations (FBSs) without excessive information exchange between femto base stations (FBSs), and between femto base stations (FBSs) and macrocell base stations (MBSs).

In another aspect, the present invention provides a system for interference mitigation in femtocell network by dynamically allocating resource blocks (RBs) to femto user equipments (FUEs). The system comprises at least a sensing module configured to sense a wireless spectrum over at least a resource block (RB) at a femto base station (FBS) for procuring a sensing measurement result (SMR), at least a femto base station (FBS) module configured to collect one of at least a channel state information (CSI) and at least a block error rate (BLER) from at least a Femto User Equipment (FUE), and at least a coordination module operationally connected to said sensing module and said femto base station (FBS) module. The resource block (RB) is one of an allocated resource block (ARB) and an unallocated resource block (URB). The femto base station (FBS) module is capable of receiving information regarding said allocated resource block (ARB) already allocated to at least said femto user equipment (FUE).

The coordination module is configured to: receive at least one of said sensing measurement result (SMR), said channel state information (CSI), said block error rate (BLER), said information regarding said allocated resource block (ARB) or any combination thereof; analyze at least one of said sensing measurement result (SMR), said channel state information (CSI), said block error rate (BLER), said information regarding allocated resource block (ARB) or any combination thereof for evaluating a Quality of Service (QoS) performance simultaneously in each of an uplink (UL) communication and a downlink (DL) communication, and instruct said femto base station (FBS) module for dynamically allocating at least a resource block (RB) to at least said femto user equipment (FUE) based on said QoS performance in each of said uplink (UL) communication and said downlink (DL) communication.

The system may be directly used as a plugged in device for using the device as a personal base station, referred to as femto base station (FBS) while avoiding interference from other femto base stations (FBSs) and macrocell BSs (MBSs). The present invention may be implemented in operator owned small cell base stations (SCBSs) for fast deployment ensuring a self organizing heterogeneous network (HetNet) avoiding inter base station (BS) communications.

In another aspect, the present invention provides a method for interference mitigation in femtocell network by dynamically allocating resource blocks (RBs) to femto user equipments (FUEs). The method comprises: sensing a wireless spectrum over at least a resource block (RB) at a femto base station (FBS) for procuring sensing measurement result (SMR), wherein at least said resource block (RB) is one of at least an allocated resource block (ARB) and at least an unallocated resource block (URB); collecting channel state information (CSI) from at least a Femto User Equipment (FUE); estimating a block error rate (BLER) for at least said resource block (RB); procuring information regarding at least an allocated resource block (ARB) which is already allocated to said at least a femto user equipment (FUE); analyzing at least one of said sensing measurement result (SMR), said collecting channel state information (CSI), said block error rate (BLER), said at least an allocated resource block information (ARBI) or any combination thereof for evaluating a Quality of Service (QoS) performance simultaneously in each of an uplink (UL) communication and a downlink (DL) communication; and dynamically allocating at least a resource block (RB) to at least said Femto User Equipment (FUE) based on said Quality of Service (QoS) performance in each of said uplink (UL) communication and said downlink (DL) communication.

In another aspect, the present invention provides a method of radio resource management (RRM) for allocating at least a resource block (RB) to at least a femto user equipment (FUE). The method comprises: receiving one of an interference level (IL) information of said at least a resource block (RB), wherein at least said resource block (RB) is one of at least an allocated resource block (ARB) and at least an unallocated resource block (URB); selecting an interference threshold (IT) for said interference level (IL) to provide reference for allocating at least said resource block (RB) to at least said femto user equipment (FUE); evaluating a value of an interference transformation function (ITF) based on said interference level (IL) information of said at least a resource block (RB); receiving a channel state information (CSI) of said at least a femto user equipment (FUE) corresponding to a channel gain (CG) of at least said femto user equipment (FUE); transforming at least said channel gain (CG) to at least a transformed channel gain (TCG) for at least said resource block (RB) using said interference transformation function (ITF); implementing a scheduling algorithm (SA) using at least said transformed channel gain (TCG); estimating a block error rate (BLER) for defining a quality of service (QoS) for at least said resource block (RB); and allocating at least said resource block (RB) to at least said femto user equipment (FUE) using said scheduling algorithm (SA) and said channel gain (CG).

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a typical femtocell network incorporating a system for interference mitigation, according to an exemplary embodiment of the present invention;

FIG. 2 illustrates a schematic diagram of the system for interference mitigation, according to an exemplary embodiment of the present invention;

FIG. 3 illustrates a flow diagram of a process of interactions between different modules of the system for interference mitigation, according to an exemplary embodiment of the present invention;

FIG. 4 illustrates a flow diagram of a method of interference mitigation in femtocell network, according to an exemplary embodiment of the present invention;

FIG. 4A illustrates a flow diagram of a method implemented by a coordination module in the uplink (UL) communication, according to an exemplary embodiment of the present invention;

FIG. 4B illustrates a flow diagram of a method implemented by the coordination module in the downlink (DL) communication, according to an exemplary embodiment of the present invention; and

FIG. 5 illustrates a flow diagram of a radio resource management (RRM) method implemented by a scheduling module, according to an exemplary embodiment of the present invention.

### DETAILED DESCRIPTION OF THE INVENTION

The exemplary embodiments described herein detail for illustrative purposes are subject to many variations in structure and design. It should be emphasized, however, that the present invention is not limited to a particular system and methods for interference mitigation in femtocell network as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including”, “comprising” or “having” and variations thereof herein are meant to encompass the items listed thereafter and equivalents thereof as well as additional items. Further, the terms, “a” and “an” herein do not denote a limitation of quantity, but rather denote the presence of at least one of the referenced item.

The terminologies herein after referred to as, resource block(s) for RB(s), allocated resource block(s) for ARB(s), allocated resource block information for ARBI, unallocated resource block(s) for URB(s), femto user equipment(s) for FUE(s), base station(s) for BS(s), femto base station(s) FBS(s), macrocell base station(s) for MBS(s), macrocell user equipment(s) for MUE(s), small cell base station(s) for SCBS(s), heterogeneous network for HetNet, mobile network operator(s) for MNO(s), digital subscriber line for DSL, Single Carrier frequency division multiple access for SCFDMA, Orthogonal frequency division multiple access for OFDMA, channel state information for CSI, block error rate for BLER, sensing measurement result for SMR, radio frequency for RF, uplink for UL, downlink for DL, radio resource management for RRM, transmission time interval for TTI, channel gain for CG, transformed channel gain for TCG, interference level information for ILI, interference transformation function for ITF, scheduling algorithm for (SA), and interference threshold for IT.

The present invention provides system and methods for interference mitigation in femtocell network by dynamically allocating the resource block to the femto user equipment while maintaining simultaneous operation of sensing and transmission. The resource blocks further comprises of at least a subcarrier. The resource block x refers to an arbitrary resource block number and can be represented as RB x.

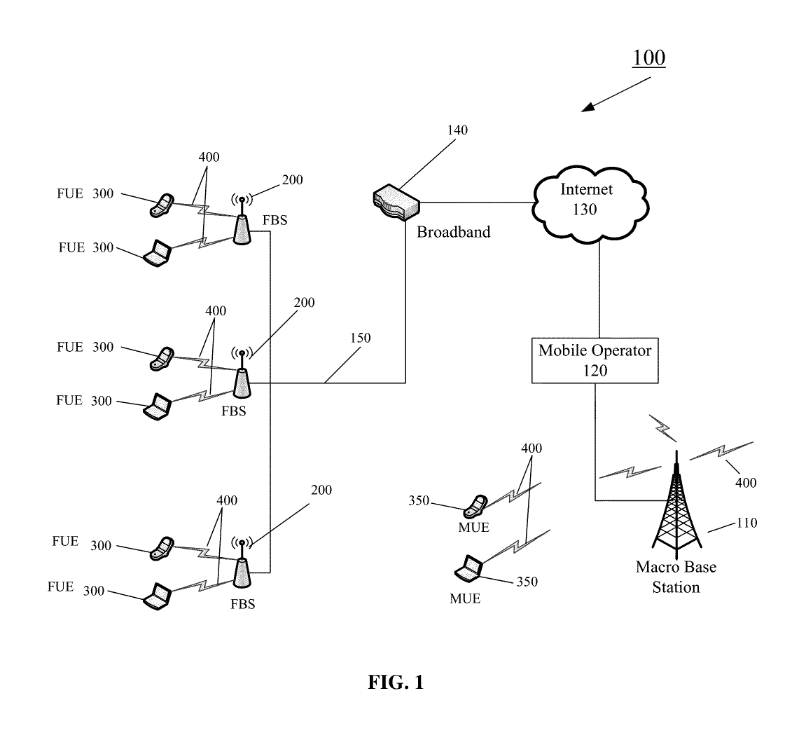

Referring to FIG. 1, which illustrates a typical femto cell network 100 incorporating a system 200 for interference mitigation, according to an exemplary embodiment of the present invention. The femto cell network 100 comprises a macro base station 110, a mobile operator 120, Internet 130, a broadband router 140, a digital subscriber lines connection 150, said system 200, a femto user equipment 300, a macrocell user equipment 350, and a communication link 400.

The systems 200 (also referred to as “femto base stations”) are provided by the mobile network operators to its customers. The systems 200 are typically smaller in size and may be easily implemented as compact base stations where more number of large sized base stations cannot be implemented to enhance the capacity and considerable data rates. The systems 200 are connected to the user's broadband 140 to connect with the Internet 130 to avail the service provided by the mobile network operators 120. Also some femtocell base stations 200 are an integrated femto base station which includes a digital subscriber line router and a femto base station.

The systems 200 are plug and play devices, therefore does not need specific installation and technical knowledge for installing a systems 200. Once the system 200 is plugged in, the system 200 connects to the mobile network operator 120 and provides extra coverage. The system 200 is configured using a web interface provided by mobile network operator 120 to authenticate user equipments that are allowed to connect to the system 200 and needs to be done only once at the beginning of configuring the system 200. The time when authenticated user equipments arrive within the range of system 200, the network automatically switches from macrocell network to femtocell network and vice versa.

The systems 200 are meant for a specific location and involve a protection mechanism, therefore any change in location is reported at the mobile network operator 120. The mobile network operator 120 may or may not allow change in location of the system 200 depending on the mobile network operator's 120 policy. However, international change in location is not permitted as the systems 200 transmits licensed frequencies which belong to different mobile network operators 120 in different countries.

The present system 200 is also used as a plugged in device for using the device as a personal base station or femto base station 200 while avoiding interference from other femto and macrocell base stations. The present invention may be also implemented in operator owned small cell base stations for fast deployment ensuring a self organizing HetNet avoiding inter base station communications.

The present invention is compliant with current standards, while being scalable and easily extendable in case of future enhancements of these standards. The system 200 of the present invention may operate and detect interference information without reducing the transmission time, without explicitly exchanging information with macrocell base stations 110, macrocell user equipments 350, and femto base stations 200 beyond usual information that are currently implemented in existing standards. The present invention may be gracefully incorporated in the future networks in order to reach a better performance.

The systems 200 are implemented when there is a limited reach of macrocell base station 110 and to increase the capacity in terms of number of user equipments that may be connected to the system 200. In the femtocell network 100, the connection from the macrocell base station 110 to systems 200 is established via the mobile operator 120 and the Internet 130. The connection of Internet 130 is distributed via broadband routers 140 to systems 200 using the digital subscriber line connection 150. The femto user equipment 300 are the user equipment connected to the system 200. The macrocell user equipment 350 are the user equipments connected to the macrocell base station 110. The connection with the user equipments are established using the communication link 400.

The communication link 400 is preferably a radio link. The user equipment may be one of a femto user equipment 300, macrocell user equipment 350 and small cell user equipment. The macrocell base station coverage area is the area till where the macrocell base station 110 may send and receive signals and femto base station coverage area is the area till where the system 200 may send and receive signals. The coverage area for system 200 and macrocell base station 110 need not be same but when there is a common area which comes under macrocell base station coverage area as well as femto base station coverage area then interference arises. The interference may also arise when two systems 200 covers a common portion of coverage area or whole portion of coverage area.

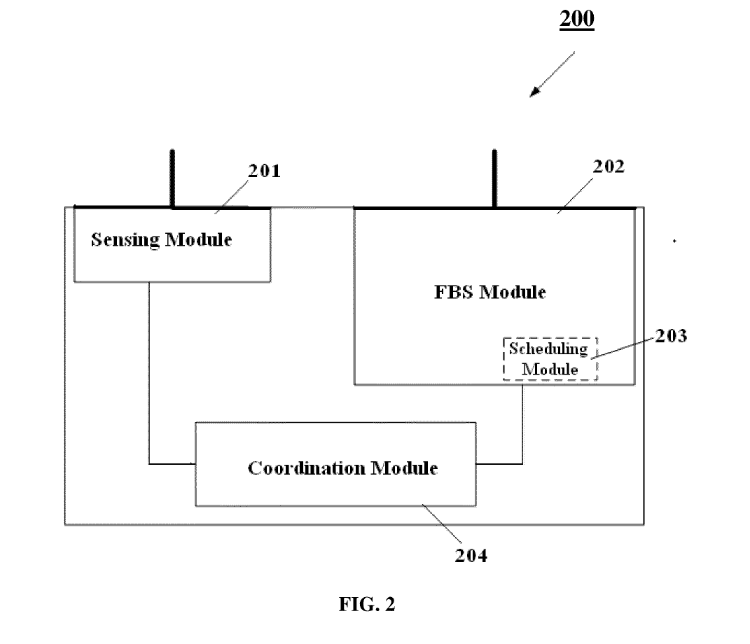

Referring to FIG. 2, which illustrates the system 200 capable of dynamically allocate resource blocks to the femto user equipments 300, according to an exemplary embodiment of the present invention. The system 200 comprises a sensing module 201, a femto base station module 202, and a coordination module 204. The femto base station module 202 further comprises a scheduling module 203. The coordination module 204 exchanges information from the sensing module 201 and the femto base station module 202, to direct the femto base station module 202 to dynamically allocate a resource block to the femto user equipment 300 for interference mitigation.

The sensing module 201 further comprises at least an antenna, at least a radio frequency chain and at least a processing unit operationally coupled to the antenna and the radio frequency. The antenna of the sensing module 201 configured to dedicatedly receive sensing information by sensing a wireless spectrum over at least said resource block in each of an uplink communication and in a downlink communication. The resource block is one of an allocated resource block and an unallocated resource block.

The sensing module 201 configured to detect the signal level over one of each OFDMA resource block and SCFDMA resource block in each of the uplink communication and the downlink communication.

The femto base station module 202 further comprises at least an antenna, at least a radio frequency chain and at least a processing unit operationally coupled to the antenna and the radio frequency. The antenna of the femto base station module 202 configured to send and receive information in each of the uplink communication and in the downlink communication. The radio resource management process is performed at the scheduling module 203. The femto base station module 202 also handles the connection and communication with femto user equipments 300.

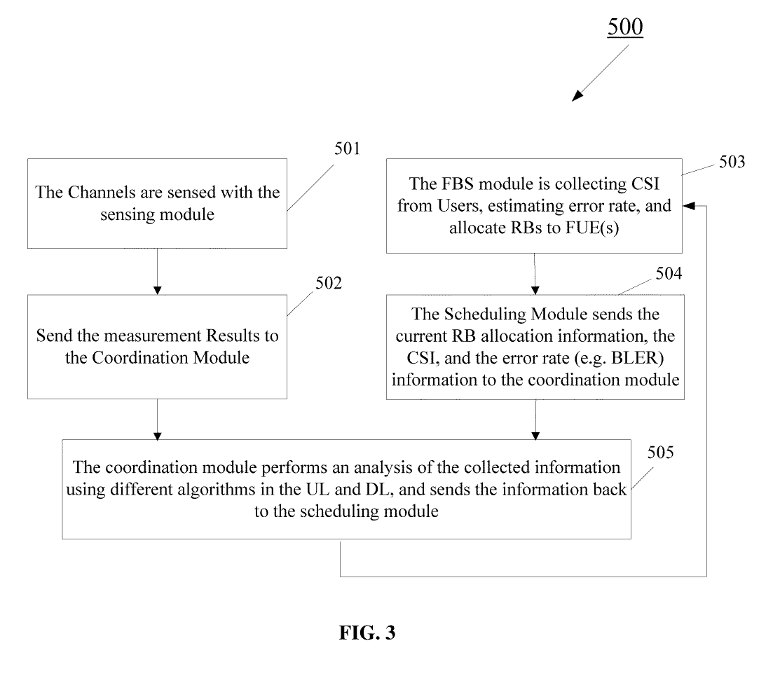

Referring to FIG. 3 which illustrates a flow diagram of a process 500 for describing the interaction amongst different modules, i.e., the sensing module 201, the femto base station module 202 and the coordination module 204 of the femto base station device 200, according to an exemplary embodiment of the present invention. The femto base station device 200 is capable of joint channel sensing and performing radio resource management process. The channel sensing is done at the sensing module 201 and radio resource management process is performed by scheduling module 203.

The flow diagram illustrated in FIG. 3 indicates the initiation of interaction with a step 501 and a step 503. At the step 501, the channels are sensed with the sensing module 201 for collecting sensing measurement results and then the sensing module sends the sensing measurement result to the coordination module 204 at a step 502. At the step 503, the femto base station module 202 collects the channel state information from the femto user equipments 300, estimating the block error rate for the resource block and collect information about the allocated resource block. At step 504, the scheduling module 203 sends the information to the coordination module 204. The information from the scheduling module 203 is collected and estimated by the femto base station module 202.

The coordination module 204 perform and analyze the information collected from the sensing module 201 and the femto base station module 202 using different algorithm separately in the uplink communication and in the downlink communication. After implementing the algorithm in each of uplink communication and downlink communication the information are send back to the femto base station module 202. The step 502 and the step 504 are preferably carried out simultaneously. The coordination module 204 also instructs the femto base station module 202 to allocate resource blocks based on the information from the femto base station module 202 and sensing module 201.

The allocation of resource blocks are based on an interference level, i.e. the resource blocks with least interference are allocated at the beginning followed by the resource blocks with more interference, without using the heavily used/interfered resource blocks. Further, it is not compulsory to allocate an unallocated resource block. This control may be performed by the radio resource management process that dynamically uses the sensing results. The method implemented in radio resource management process allows the scheduling module 203 to adapt to the interference scenario through channel sensing information, ranging from the most tolerant to the most stringent towards the detected interference.

The femto base station device 200 of the present invention is capable of dynamically incorporating the impact of both channel fading fluctuations and interference levels without requiring additional information exchange between systems 200 and femto user equipments 300 beyond channel sensing information feedback information.

In an exemplary embodiment of the present invention, when system 200 is itself transmitting the signals in the downlink communication over a given resource block. The transmitted signals may be subtracted from the total signal power sensed at the sensing antenna of sensing module 201. Since, the system 200 knows the signal it is transmitting from the transmitting femto base station antenna, an accurate estimate of the version of this signal received at the sensing antenna of the sensing module 201 may be obtained. Thus, the interference level on a given resource block may be estimated as:

$$Interference power on a RB = ( Total measured signal power over a RB at the sensing antenna ) - ( FBS transmission power over a RB , estimated at the sensing antenna )$$

The measured interference levels are sent to the scheduling module 203 of the femto base station module 202. The scheduling module 203 uses the interference information in conjunction with channel state information from femto user equipments 300 in order to assign the resources accordingly. In the uplink communication, the femto user equipment 300 is the one which is transmitting the signals to the system 200. Thus, the system 200 cannot know the signal in advance transmitted by the femto user equipment 300. Therefore, the femto user equipment 300 may be scheduled initially on one of a given resource block and set of resource blocks, while the other resource blocks are being sensed simultaneously. Then the radio resource management allocates one of another resource block and set of resource blocks to the femto user equipment 300 based on the sensing measurements, while the initial resource blocks are simultaneously sensed along with any unallocated resource blocks. The switching between the sensed resource blocks and the allocated resource blocks is performed depending on the quality of performance, e.g. the block error rate dropping below a threshold. The switching between the sensed resource blocks and the allocated resource blocks refers to here is the dynamic allocation of resource blocks.

In an embodiment, the present invention may be implemented in HetNet, in operator owned small cell base stations for fast deployment, similarly to a plug and play fashion ensuring a self organizing HetNets avoiding inter base station communications, e.g. over the X2 interface in LTE.

In an exemplary embodiment, the present invention may be implemented on small cell base stations to enhance radio resource management performance through joint sensing and radio resource management at a faster time scale, while the information exchanged on the X2 interface at a slower time scale may help make longer term resource management decisions.

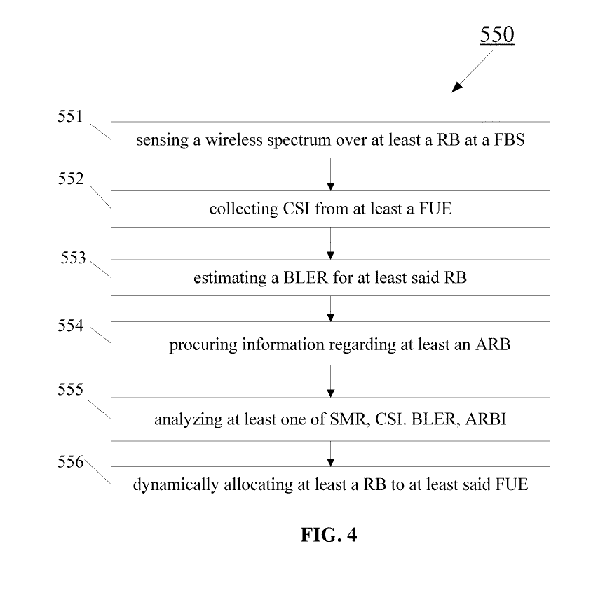

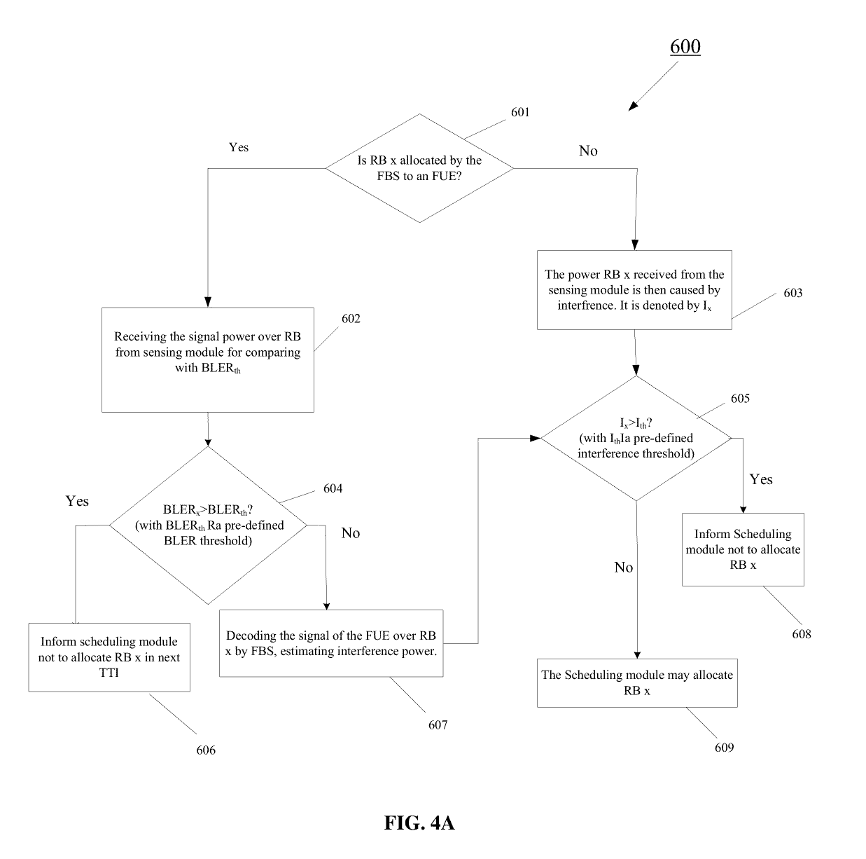

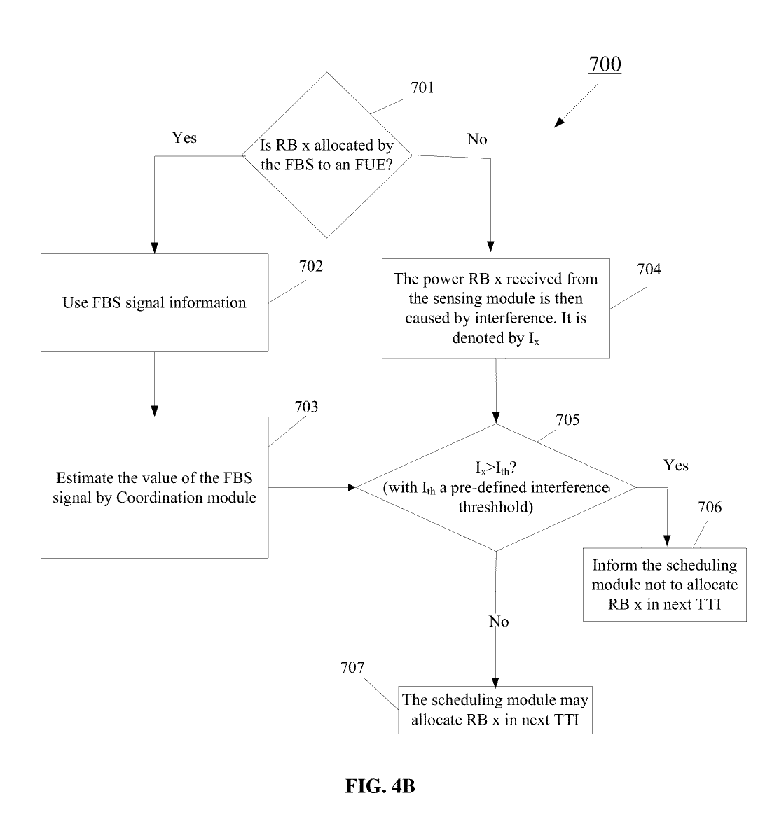

Referring to FIG. 4, illustrated is the flow diagram of a method 550 of interference mitigation in femtocell network, according to an exemplary embodiment of the present invention. The method 550 begins at step 551, which involves sensing a wireless spectrum over at least a resource block for procuring sensing measurement result, wherein at least said resource block is one of at least an allocated resource block and at least an unallocated resource block. At a step 552, the channel state information is collected from the femto user equipment 300. At a step 553, the block error rate is estimated for at least a resource block.

At a step 554, the information regarding the at least an allocated resource block is procured which is already allocated to the at least a femto user equipment. At a step 555, one of the sensing measurement result, the channel state information, the block error rate, the at least an allocated resource block information or any combination thereof are analyzed for evaluating a Quality of service performance simultaneously in each of uplink communication and downlink communication. At a step 556, the at least a resource block is allocated dynamically to the at least a femto user equipment based on the Quality of Service performance in each of the uplink communication and the downlink communication.

Referring to FIG. 4A, illustrated is the flow diagram of a method 600 which is implemented by the coordination module 204 in the uplink communication, according to an exemplary embodiment of the present invention. The process 600 begins at a step 601, which involves information of whether a resource block is allocated by the system 200 to the femto user equipment 300. If the resource block is allocated by the system 200 to the femto user equipment 300, the signal power over a resource block is received from the sensing module 201 containing the total interference along with the power received from femto user equipment 300 over the resource block at a step 602. The femto user equipment 300 signal cannot be known in advance at the system 200, so the interference cannot be isolated. The system 200 may use block error rate information to check if it is higher than acceptable block error rate threshold (BLERₜₕ).

At a step 604, if the block error rate is higher than the defined block error rate threshold (BLERₜₕ), a resource block which is subjected to interference and the coordination module 204, informs the scheduling module 203 not to allocate resource block to femto user equipment 300 in the next transmission time interval at a step 606. This will avoid interference on resource block at current system 200 and prevent the system 200 from causing interference at other macrocell base stations 110 or systems 200 by allocating the resource block to a femto user equipment 300. The sensing of the resource block in the next transmission time interval will allow determining the exact interference level since it will not be allocated by the scheduling module 203 of the system 200. At a step 604, if the block error rate is not higher than the defined block error rate threshold (BLERₜₕ) then the system 200 may decode the signal of the femto user equipment 300 over a resource block. Consequently at a step 607, the system 200 may have an estimate of the interference power (Iₓ) where,

Iₓ=(Total received power)−(Estimated signal power)

At the step 601, if a resource block is not allocated by the system 200 to the femto user equipment 300, the signal power over a resource block is received from the sensing module 201 is then caused by interference (Iₓ) at a step 603.

At a step 605, if the interference (Iₓ) is higher than an interference threshold (Iₜₕ), the resource block is being used by one of an macrocell user equipment 350 and a femto user equipment 300 of another system 200, the coordination module 204 informs the scheduling module 203 not to allocate a resource block in the next transmission time interval at a step 608. This will avoid interference to other systems 200 and macrocell base stations 110. At the step 605, if the interference (Iₓ) is not higher than the interference threshold (Iₜₕ), the resource block is not subjected to significant interference, the coordination module 204 informs the scheduling module 203 to allocate a resource block in the next transmission time interval at a step 609.

Referring to FIG. 4B which illustrates a flow diagram of a method 700 implemented by the coordination module 204 in the downlink communication. The method 700 begins at step 701, which involves information of whether a resource block allocated by the system 200 to a femto user equipment 300. If a resource block is allocated by the system 200 to the femto user equipment 300, the signal power over a resource block is received from the sensing module 201 containing the total interference along with the power received from the transmission of system 200 over the resource block at a step 702. The system 200 signal may be known in advance since the femto base station module 202 may communicate to the coordination module 204.

At a step 703, the coordination module 204 estimates the value of femto base station signal over resource block received at the antenna of the sensing module 201 for a known distance between the two antennas which are also in relatively closer distance. The coordination module 204 estimates the interference power by:

Iₓ=(total received power over RBₓ)−(Transmitted signal power by the FBS over RBₓ, estimated at the sensing module 201)

At a step 705, the estimated interference power (Iₓ) is compared with an interference threshold Iₜₕ. If the estimated interference power (Iₓ) is higher than the interference threshold Iₜₕ, the resource block is being used by one of a macrocell base station 110 and a system 200, the coordination module 204 informs the scheduling module 203 not to allocate a resource block in the next transmission time interval at a step 706. This will avoid interference at the system 200 and femto user equipment 300 and prevent it from causing interference to other femto user equipments 300 and macrocell base stations 110. At the step 705, if the interference (Iₓ) is not higher than the interference threshold (Iₜₕ), the resource block is not subjected to significant interference and the coordination module 204, the coordination module 204 informs the scheduling module 203 to allocate a resource block in the next transmission time interval at a step 707.

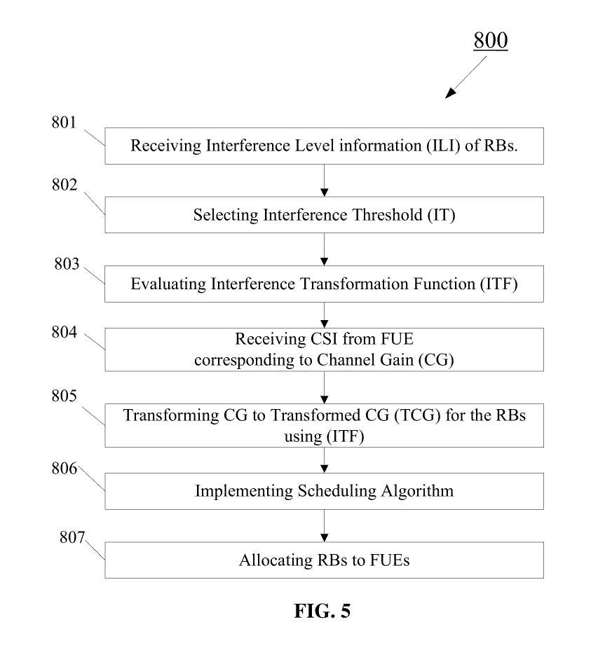

Referring to FIG. 5 which illustrates a flow diagram of a radio resource management method 800 implemented by the scheduling module 203, according to an exemplary embodiment of the present invention. The radio resource management method 800 initiate at a step 801 by receiving interference level information of resource blocks. At a step 802, an interference level threshold is selected for setting a reference for the interference level. At a step 803, the interference transformation function value is evaluated. The value of the interference transformation function is in the range of 0 (zero) to 1 (one), wherein 0 indicates interference above a predefined threshold and 1 indicates no interference at all.

In an embodiment, a linear function F(Iₓ)=1−min(Iₓ/Iₜₕ, 1) is used as interference transformation function. A linear function may be used to allow the interference transformation function to decrease proportionally to the increase in interference, until reaching the interference threshold. Depending on the embodiment and interference tolerance level, different interference transformation function may be used. A step function may be used if absolutely no interference is accepted or tolerated beyond a specified threshold, but may be considered negligible below that threshold. An exponential function may be used if a sharp decrease is required when the interference increases, while still using a soft value, for example 0.3, 0.45, 0.56 etc. A logarithmic function may be used if the decrease of the interference transformation function with interference may be tolerated to be slow.

At a step 804, the channel state information is received from femto user equipment 300 corresponding to a channel gain of an arbitrary FUEi over an arbitrary RBx. The CG is represented by H_{i,x} for an arbitrary FUEi and an arbitrary RBx.

At a step 805, the channel gain is transformed to a virtual channel gain or transformed channel gain. The transformed channel gain is represented by H*. The channel gain of the resource blocks are transformed to transformed channel gain using interference transformation function. The transformed channel gain is set to H*_{i,x}=F(Iₓ). H_{i,x} for all user equipments and resource blocks.

At a step 806, the scheduling module 203 uses the transformed channel gain in implementing channel state information aware algorithms. The algorithms allow providing higher priorities for resource blocks subjected to the least interference to be allocated first. The algorithm also provide low priorities for resource blocks subjected to higher interference, in this case the resource blocks are allocated only when the resource blocks having a higher transformed channel gain are not sufficient.

The use of transformed channel gain by the scheduling algorithm implemented in the radio resource management method 800 is dedicated to determining the priorities of allocating resource blocks, sorting the resource blocks of a given femto user equipment 300 in terms of their quality, etc. However, the estimation of the achievable data rates of given femto user equipment 300 during the implementation of the algorithm is done using the actual channel gain. The achievable data rates of given femto user equipment 300 during the implementation is estimated in order to determine if the allocated resource blocks are sufficient to reach the desired quality of service.

At a step 807, the resource blocks are allocated to femto user equipments 300 by implementing the scheduling algorithm. The transformed channel gain is used in the scheduling algorithm for dedicatedly determining the priorities of allocating resource blocks, sorting the resource blocks of a given femto user equipment 300 in terms of their quality, etc. The achievable data rates of given femto user equipment 300 during the implementation of the algorithm is done using the actual channel gain.

The techniques, devices, subsystems and methods described and illustrated in the various exemplary embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A method for interference mitigation in a femtocell network, the method comprising:
sensing a wireless spectrum over at least a resource block (RB) at a femto base station (FBS) for procuring sensing measurement result (SMR), wherein at least said resource block (RB) is one of at least an allocated resource block (ARB) and at least an unallocated resource block (URB);
collecting channel state information (CSI) from at least a Femto User Equipment (FUE);
estimating a block error rate (BLER) for at least said resource block (RB);
procuring information regarding at least an allocated resource block (ARB) which is already allocated to said at least a femto user equipment (FUE);
analyzing at least one of said sensing measurement result (SMR), said collecting channel state information (CSI), said block error rate (BLER), said at least an allocated resource block information (ARBI) or any combination thereof for evaluating a Quality of Service (QoS) performance simultaneously in each of an uplink (UL) communication and a downlink (DL) communication; and
dynamically allocating at least a resource block (RB) to at least said Femto User Equipment (FUE) based on said Quality of Service (QoS) performance in each of said uplink (UL) communication and said downlink (DL) communication.

2. The method of claim 1, wherein at least said resource block (RB) comprises at least a subcarrier.

3. The method of claim 1, wherein sensing at least said resource block (RB) further comprises sensing at least said subcarrier over said wireless spectrum at said femto base station (FBS) in at least one of said uplink (UL) communication and said downlink (DL) communication.

4. The method of claim 1, wherein procuring said sensing measurement result (SMR) comprises estimating at least an interference level in at least said resource block (RB) in at least one of said uplink (UL) communication and said downlink (DL) communication.

5. The method of claim 4, wherein estimating at least said interference level comprises subtracting a transmission power over said resource block (RB) by said femto base station (FBS) from a total measured signal power over said resource block (RB) in said downlink (DL) communication.

6. The method of claim 4, wherein estimating at least said interference level comprises subtracting a received power over said resource block (RB) by said femto base station (FBS) from a total measured signal power over said resource block (RB) in said uplink (UL) communication.

7. The method of claim 1, further comprising allocating at least said resource block (RB) to at least said Femto user Equipment (FUE) initially and simultaneously sensing of at least a resource block (RB) other than at least said allocated resource block (ARB) in at least one of said uplink (UL) communication and said downlink (DL) communication.

8. The method of claim 1, further comprising allocating at least said resource block (RB) to at least said Femto user Equipment (FUE) initially and simultaneously sensing of at least a resource block (RB) other than at least said allocated resource block (ARB) in said downlink (DL) communication.

9. The method of claim 1, further comprises sending one of said sensing measurement result (SMR), said collecting channel state information (CSI), said block error rate (BLER), at least said allocated resource block information (ARBI) or any combination thereof for evaluating a Quality of Service (QoS) performance simultaneously in each of said uplink (UL) communication and said downlink (DL) communication.

10. The method of claim 1, further comprises sending said interference level for using in conjunction with at least one of received said sensing measurement result (SMR), said channel state information (CSI), said block error rate (BLER) and at least said allocated resource block information (ARBI) or any combination thereof for evaluating said Quality of Service (QoS) performance.

11. The method of claim 1, further comprises sending information about said Quality of Service (QoS) performance to scheduling module for implementing at least a radio resource management (RRM) method in at least one of said uplink (UL) communication and said downlink (DL) communication.

12. The method of claim 11, further comprises dynamically allocating at least said resource block (RB) to at least said femto user equipment (FUE) based on said Quality of Service (QoS) performance in each of said uplink (UL) communication and said downlink (DL) communication based on at least a said radio resource management (RRM).

13. The method of claim 1, wherein dynamic allocation of at least said resource block (RB) performed based on said quality of service (QoS) performance information, is one of at least said allocated resource block (ARB) and at least said unallocated resource block (URB) or any combination of at least said allocated resource block (ARB) and at least said unallocated resource block (URB).

14. A system for interference mitigation in a femtocell network, the system comprising:
at least a sensing module configured to sense a wireless spectrum over at least a resource block (RB) at a femto base station (FBS) for procuring a sensing measurement result (SMR), wherein at least said resource block (RB) is one of an allocated resource block (ARB) and an unallocated resource block (URB);
at least a femto base station (FBS) module configured to collect one of at least a channel state information (CSI) and at least a block error rate (BLER) from at least a Femto User Equipment (FUE), wherein said femto base station (FBS) module is capable of receiving information regarding said allocated resource block (ARB) already allocated to at least said femto user equipment (FUE); and
at least a coordination module operationally connected with said sensing module and said femto base station (FBS), said coordination module is configured to
receive at least one of said sensing measurement result (SMR), said channel state information (CSI), said block error rate (BLER), said information regarding said allocated resource block (ARB) or any combination thereof,
analyze at least one of said sensing measurement result (SMR), said channel state information (CSI), said block error rate (BLER) and said information regarding allocated resource block (ARB) or any combination thereof for evaluating a Quality of Service (QoS) performance simultaneously in each of an uplink (UL) communication and a downlink (DL) communication, and
instruct said femto base station (FBS) module for dynamically allocating at least a resource block (RB) to at least said femto user equipment (FUE) based on said QoS performance in each of said uplink (UL) communication and said downlink (DL) communication.

15. The system of claim 14, wherein at least said resource block (RB) is one of an orthogonal frequency division multiple access (OFDMA) and a Single Carrier frequency division multiple access (SCFDMA).

16. The system of claim 14, wherein said channel state information (CSI) is collected from said femto user equipment (FUE) for at least said allocated resource block (ARB) and at least said unallocated resource block (URB).

17. The system of claim 14, wherein said block error rate (BLER) is estimated at said femto base station (FBS) module.

18. The system of claim 14, wherein said sensing measurement result (SMR) and said channel state information (CSI) are received for at least one of said allocated resource block (ARB) and said unallocated resource block (URB).

19. The system of claim 14, wherein said sensing module comprises at least an antenna, at least a radio frequency (RF) chain and at least a processing unit operationally coupled to at least said antenna and at least said radio frequency (RF).

20. The system of claim 14, wherein said femto base station (FBS) module comprises of at least an antenna, at least a radio frequency (RF) chain and at least a processing unit operationally coupled to said at least an antenna and said at least a radio frequency (RF).

21. The system of claim 19, wherein at least said antenna of said sensing module is configured to dedicatedly receive sensing information by sensing said wireless spectrum over at least said resource block (RB) in each of said uplink (UL) communication and said downlink (DL) communication.

22. The system of claim 20, wherein at least said antenna of said femto base station (FBS) module is configured to send and receive information in each of said uplink (UL) communication and said downlink (DL) communication.

23. The system of claim 14, wherein said coordination module is capable of estimating an interference level, using said sensing measurement result (SMR) from said sensing module.

24. The system of claim 14, wherein said femto base station (FBS) module further comprises a scheduling module capable of performing a radio resource management (RRM) method for allocating at least said resource block (RB).

25. A method of radio resource management (RRM) for allocating at least a resource block (RB) to at least a femto user equipment (FUE), the method comprising:
receiving one of an interference level (IL) information of said at least a resource block (RB), wherein at least said resource block (RB) is one of at least an allocated resource block (ARB) and at least an unallocated resource block (URB);
selecting an interference threshold (IT) for said interference level (IL) to provide reference for allocating at least said resource block (RB) to at least said femto user equipment (FUE);
evaluating a value of an interference transformation function (ITF) based on said interference level (IL) information of said at least a resource block (RB);
receiving a channel state information (CSI) of said at least a femto user equipment (FUE) corresponding to a channel gain (CG) of at least said femto user equipment (FUE);
transforming at least said channel gain (CG) to at least a transformed channel gain (TCG) for at least said resource block (RB) using said interference transformation function (ITF);
implementing a scheduling algorithm (SA) using at least said transformed channel gain (TCG);
estimating a block error rate (BLER) for defining a quality of service (QoS) for at least said resource block (RB); and
allocating at least said resource block (RB) to at least said femto user equipment (FUE) using said scheduling algorithm (SA) and said channel gain (CG).

26. The method of radio resource management (RRM) as claimed in claim 25, wherein said interference level is based on amount of an interference present in at least said resource block (RB).

27. The method of radio resource management (RRM) as claimed in claim 25, wherein said value of said interference transformation function (ITF) is in a range of 0 (zero) and 1 (one), wherein said value 1 (one) indicates absence of said interference and said value 0 (zero) indicates interference above said interference threshold (IT).

28. The method of radio resource management (RRM) as claimed in claim 27, wherein said interference transformation function (ITF) is one of a step function, a linear function, an exponential function, and a logarithmic function depending on said interference level.

29. The method of radio resource management (RRM) as claimed in claim 25, wherein said transforming at least said channel gain (CG) to at least said transformed channel gain (TCG) comprises multiplying at least said channel gain (CG) with said interference transformation function (ITF).

30. The method of radio resource management (RRM) as claimed in claim 25, wherein said allocation comprises prioritizing said at least a resource block (RB) based on said scheduling algorithm (SA) implemented in said radio resource management (RRM) method.

31. The method of radio resource management (RRM) as claimed in claim 30, wherein said allocation comprises estimation of an achievable data rate of at least said femto user equipment (FUE) based on a quality of service (QoS).
